(19) United States
(12) Patent Application Publication
(10) Pub. No.: US 2005/0253967 A1
(43) Pub. Date: Nov. 17, 2005

(54) Broadcast receiving apparatus and broadcast receiving method

(75) Inventor: Riichiro Yoshida, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/118,770

(22) Filed: May 2, 2005

(30) Foreign Application Priority Data
May 12, 2004 (JP) 2004-142294

(51) Int. Cl. H04N 5/445

(52) U.S. Cl. 348/556; 348/555

(57) ABSTRACT

Having received a pseudo HDTV picture signal obtained by upwardly converting a composite format picture signal which conforms to an SDTV picture format and adding side panel images, a television receiving apparatus causes a down converter to convert the received pseudo HDTV picture signal into an SDTV picture format. Then, the television receiving apparatus causes a picture processing section to apply a three-dimensional YC separation processing to the converted signal, thereby reducing a cross color interference or a dot interference with high performance and improve an image quality. Then, the improved image is converted into an HDTV picture format by the up converter, and the converted image is displayed as a picture.

### CROSS-REFERENCE TO RELATED APPLICATIONS

This application is based upon and claims the benefit of priority from prior Japanese Patent Application No. 2004-142294, filed May 12, 2004, the entire contents of which are incorporated herein by reference.

### BACKGROUND OF THE INVENTION

1. Field of the Invention

The present invention relates to a broadcast receiving apparatus and a broadcast receiving method for receiving a digital broadcast in which plural types of picture signals having different picture formats coexist.

2. Description of the Related Art

As is well known, in a broadcasting satellite (BS) digital broadcast and a terrestrial wave digital broadcast etc., there coexist: a standard television (SDTV) picture format having 525 scanning lines and an aspect ratio of 4:3; and a high image quality high definition television (HDTV) picture format having 720 or 1125 scanning lines and an aspect ratio of 16:9.

In this case, in the HDTV picture format, the picture sources include only a component format picture signal separated into a luminescence signal and a color signal. In contrast, in the SDTV picture format, the picture sources can include two types of picture signals, i.e., a component format picture signal; and a composite format picture signal obtained by combining a luminescence signal and a color signal.

Therefore, at the broadcast station side, in the case where the picture source includes a composite format picture signal, picture processing such as YC separation processing is applied to its picture signal, and the applied signal is converted into a component form a picture signal. Then, predetermined picture encode processing is applied so as to transmit a digital broadcast signal.

Then, the receiver side receives a digital broadcast signal, and applies picture decoding processing to the received signal. Then, a component format picture signal is obtained so as to be displayed as a picture on a screen.

However, if the performance of the YC separation processing at the broadcast station side is not sufficient, while the picture signal obtained by converting a composite format into a component format includes a component of cross color interference or a dot interference, picture encode processing is carried out, and a digital broadcast signal is transmitted. When the receiver side receives the digital broadcast signal, applies decoding processing to the received signal, and displays the decoded signal as a picture, there occurs a problem that a cross color interference or a dot interference often occurs.

In Jpn. Pat. Appln. KOKAI Publication No. 2003-70018, there is disclosed a configuration of a receiver in which, when a received picture signal conforms to the SDTV picture format, the component format picture signal is converted into a composite format picture signal, and three-dimensional TC separation processing is applied, whereby a luminescence signal and a color signal are separated from each other with high performance so as to improve an image quality.

In the meantime, currently, upward converting processing is applied to the composite format picture signal which conforms to the SDTV picture format so as to adjust a vertical size to the HDTV picture format, and side panel images such as black pictures are added to both sides thereof, whereby the added side panel image is converted into the HDTV picture format having an aspect ratio of 16:9, and the converted side panel image is transmitted.

Having thus received a so-called pseudo HDTV picture signal obtained by converting the picture signal which conforms to the SDTV picture format into the HDTV picture format in this way, the receiver disclosed in Jpn. Pat. Appln. KOKAI Publication No. 2003-70018 determines that the received signal conforms to the HDTV picture format. Thus, a series of processing operations for converting that picture signal into the composite format, and carrying out three-dimensional YC separation are not applied, thus making it impossible to eliminate the above-described cross color interference or dot interference.

### BRIEF SUMMARY OF THE INVENTION

According to one aspect of the present invention, there is provided a broadcast receiving apparatus comprising: a receiver section configured to receive a digital broadcast in which there coexist a first picture signal which conforms to a standard picture format, a second picture signal which conforms to a high image quality picture format, and a third picture signal obtained by converting a composite format picture signal which conforms to a standard picture format into a high image quality picture format and adding side panels; a signal processing section configured to extract a signal of a predetermined channel from a digital broadcast signal received by the receiver section and apply decoding processing; a determining section configured to determine whether a picture signal outputted from the signal processing section is any of the first to third picture signals; a first processing section configured to guide to a picture display device the second picture signal which is selected in the case where the determining section determines that the picture signal outputted from the signal processing section is the second picture signal, and which is outputted from the signal processing section; a second processing section configured to convert into a composite format picture signal the first picture signal which is selected in the case where the determining section determines that the picture signal outputted from the signal processing section is the first picture signal, and which is outputted from the signal processing section, followed by applying three-dimensional picture processing to the converted signal and guiding the processed signal to the picture display device; and a third processing section configured to convert into a composite format picture signal which conforms to a standard picture format the first picture signal which is selected in the case where the determining section determines that the picture signal outputted from the signal processing section is the third picture signal, and which is outputted from the signal processing section, followed by applying three-dimensional picture processing to the converted signal and guiding the processed signal to the picture display device.

According to another aspect of the present invention, there is provided a broadcast receiving method comprising: a first step of receiving a digital broadcast in which there coexist a first picture signal which conforms to a standard picture format, a second picture signal which conforms to a high image quality picture format, and a third picture signal obtained by converting a composite format picture signal which conforms to a standard picture format into a high image quality picture format and adding side panels; a second step of extracting a signal of a predetermined channel from a received digital broadcast signal and applying decoding processing; a third step of determining whether the decided picture signal is any of the first to third picture signals; a fourth step of, when it is determined that the decoded picture signal is the second picture signal, guiding the second picture signal to a picture display device; a fifth step of, when it is determined that the decoded picture signal is the first picture signal, converting the first picture signal into a composite format picture signal, followed by applying three-dimensional picture processing to the converted signal and guiding the processed signal to the picture display device; and a sixth step of, when it is determined that the decoded picture signal is the third picture signal, converting the third picture signal into a composite format picture signal which conforms to a standard picture format, followed by applying three-dimensional picture processing to the converted signal and guiding the processed signal to the picture display device.

### BRIEF DESCRIPTION OF THE SEVERAL VIEWS OF THE DRAWING

FIG. 1 is a block diagram depicting a configuration of a broadcast receiving apparatus according to a first embodiment of the present invention;

FIG. 2 is a view showing a screen display in order to illustrate an HDTV picture signal having side panel images in the first embodiment added thereto;

FIG. 3 is a block diagram depicting a detailed configuration of a picture processing section of the broadcast receiving apparatus in the first embodiment;

FIG. 4 is a view illustrating an operation of a down converter of the broadcast receiving apparatus in the first embodiment;

FIG. 5 is a flow chart illustrating an operation of the broadcast receiving apparatus in the first embodiment;

FIG. 6 is a block diagram depicting a modified example of the picture processing section of the broadcast receiving apparatus in the first embodiment;

FIG. 7 is a block diagram depicting a configuration of a broadcast receiving apparatus according to a second embodiment of the present invention;

FIG. 8 is a flow chart illustrating an operation of the broadcast receiving apparatus in the second embodiment;

FIG. 9 is a block diagram depicting a configuration of a broadcast receiving apparatus according to a third embodiment of the present invention;

FIG. 10 is a view illustrating a frequency spectrum of a luminescence signal in the third embodiment;

FIG. 11 is a view illustrating downward converting and upward converting operations of the broadcast receiving apparatus in the third embodiment; and

FIG. 12 is a flow chart illustrating an operation of the broadcast receiving apparatus in the third embodiment.

### DETAILED DESCRIPTION OF THE INVENTION

### First Embodiment

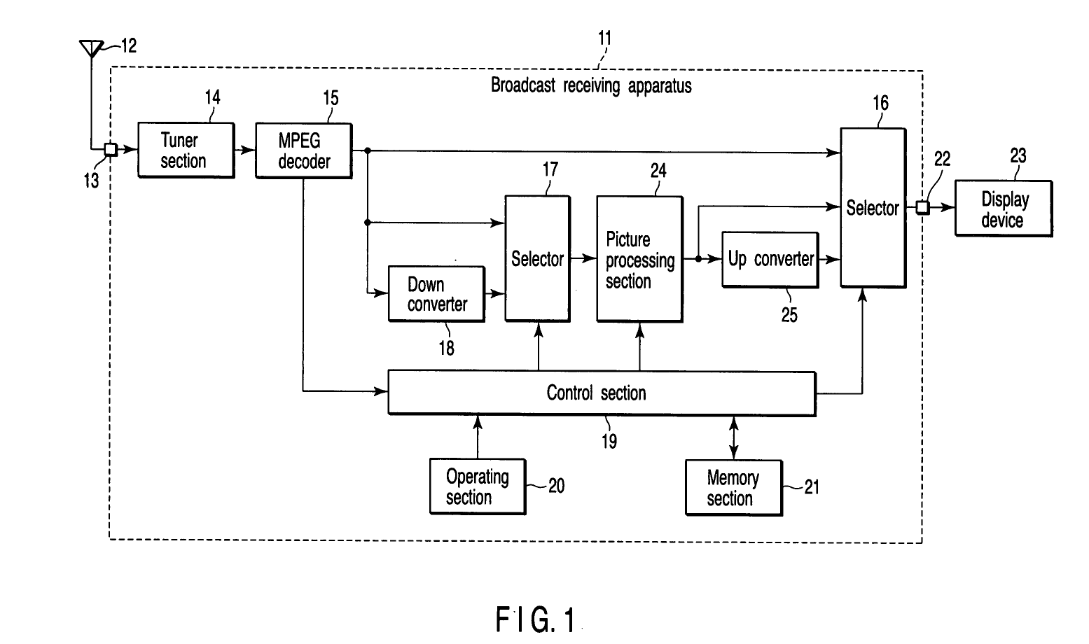

Hereinafter, one embodiment of the present invention will be described with reference to the accompanying drawings. In FIG. 1, reference numeral 11 denotes a broadcast receiving apparatus. In this broadcast receiving apparatus 11, upward converting processing is applied to: a picture signal which conforms to an HDTV picture format; a picture signal which conforms to an SDTV picture format; and a picture signal which conforms to an SDTV picture format, and a digital broadcast signal is received while these upwardly converted signals and a picture signal having side panel images added thereto (hereinafter, referred to as a pseudo HDTV picture signal) coexist. It is assumed that, from the broadcast station, information indicating a picture format and information indicating the presence or absence of side panel images are transmitted together with the digital broadcast signal.

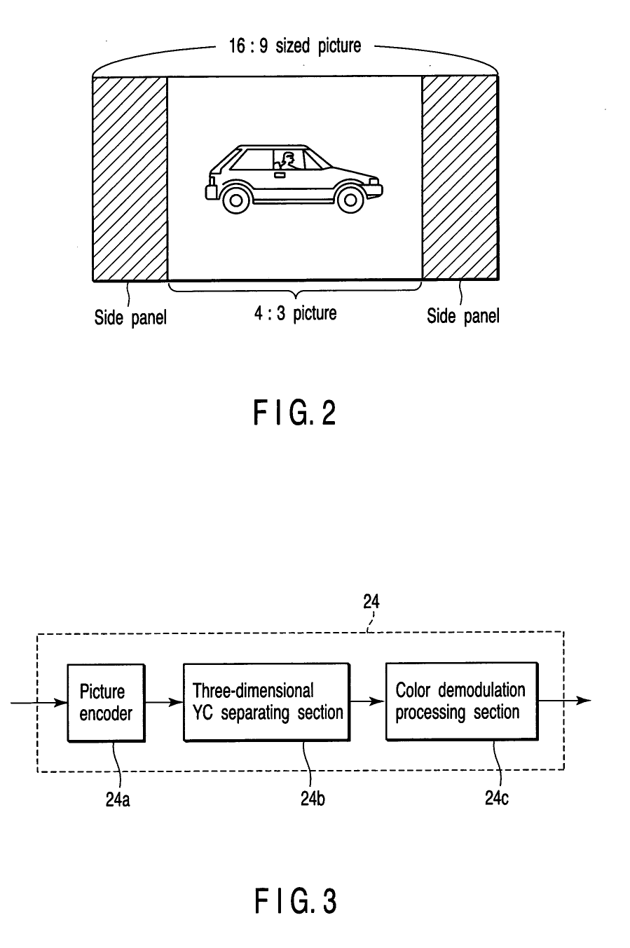

FIG. 2 shows an example of the pseudo HDTV picture signal. That is, at the broadcast station side, YC separation processing is applied to a composite format picture signal which conforms to an SDTV picture format whose aspect ratio is 4:3, and then, upward converting processing is applied so as to a vertical size to an HDTV picture format. In addition, side panel images such as black pictures are added to both sides thereof. In this manner, a pseudo HDTV picture signal having an aspect ratio of 16:9 is generated and transmitted.

Turning to FIG. 1, the digital broadcast signal is received by an antenna 12, and the received signal is supplied to a tuner section 14 via an input terminal 13. The tuner section 14 extracts a transport stream (TS) signal of a predetermined channel from among the inputted digital broadcast signals. In addition to a picture signal and a voice signal, information indicating a picture format and information indicating the presence or absence of side panel images are multiplied on the TS signal.

The TS signal extracted by the tuner section 14 is supplied to a moving picture experts group (MPEG) decoder 15. The MPEG decoder 15 applies MPEG decoding processing to the inputted TS signal, and outputs the processed picture signal to selectors 16 and 17 and a down converter 18.

The MPEG decoder 15 also decodes the information indicating a picture format and the information indicating the presence or absence of side panel images from the inputted TS signal, and outputs the decoded information to a control section 19. This control section 19 incorporates a central processing unit (CPU) or the like, receives operating information from an operating section 20 or a remote controller (not shown), and integrally controls an operation of each section of the broadcast receiving apparatus 11 such that its operating contents are reflected.

In this case, the control section 19 utilizes a memory section 21. That is, the memory section 21 essentially includes a read only memory having stored therein a control program executed by the CPU of the control section 19, a read and write memory for providing a work area to the CPU, and a nonvolatile memory having stored therein a variety of setting information and control information.

In the case where the information indicating a picture format indicates an HDTV picture format, and the information indicating the presence and absence of side panel images indicates the absence of the side panel image, the control section 19 determines that an HDTV picture signal is generated, and controls the selector 16 so as to select an output of the MPEG decoder 15. In this manner, the picture signal which conforms to the HDTV picture format is supplied to a display device 23 via an output terminal 22, and the picture which conforms to the HDTV picture format is displayed.

In addition, in the case where the information indicating a picture format indicates an SDTV picture format, the control section 19 determines that an SDTV picture signal is generated, and controls the selector 17 so as to select an output of the MPEG decoder 15. In this manner, the picture signal which conforms to the SDTV picture format is supplied to a picture processing section 24. The picture processing section 24 applies picture processing between frames or between fields to the picture signal which conforms to the SDTV picture format. This makes it possible to reduce a cross color interference or a dot interference included in the SDTV picture signal.

FIG. 3 shows the picture processing section 24 in detail. That is, the SDTV picture signal selected by the above selector 17 is supplied to a picture encoder 24a. The picture encoder 24a converts the SDTV picture signal which conforms to the component format into a composite format picture signal obtained by combining a luminescence signal and a color signal which conforms to an national television system committee (NTSC) system, and outputs the converted signal to a three-dimensional TV separating section 24b.

The three-dimensional YC separating section 24b applies YC separation processing having higher performance than that applied on the broadcast station side to the inputted picture signal, thereby reducing a cross color interference or a dot interference and improving an image quality. Then, the SDTV picture signal which conforms to the component format, outputted from the three-dimensional YC separating section 24b is outputted after color demodulation processing has been applied to the signal by means of a color demodulation processing section 24c.

In the case where the information indicating a picture format indicates an SDTV picture format, the control section 19 controls the selector 16 so as to select an output of the picture processing section 24. In this manner, a picture signal which conforms to the SDTV picture format in which the cross color interference or dot interference has been reduced, is supplied to the display device 23 via the output terminal 22, and a picture which conforms to the SDTV picture format is displayed.

Now, a description will be given with respect to a case in which the pseudo HDTV picture signal shown in FIG. 2 has been received, namely, a case in which the information indicating the presence or absence of side panel images indicates the presence of the side panel image.

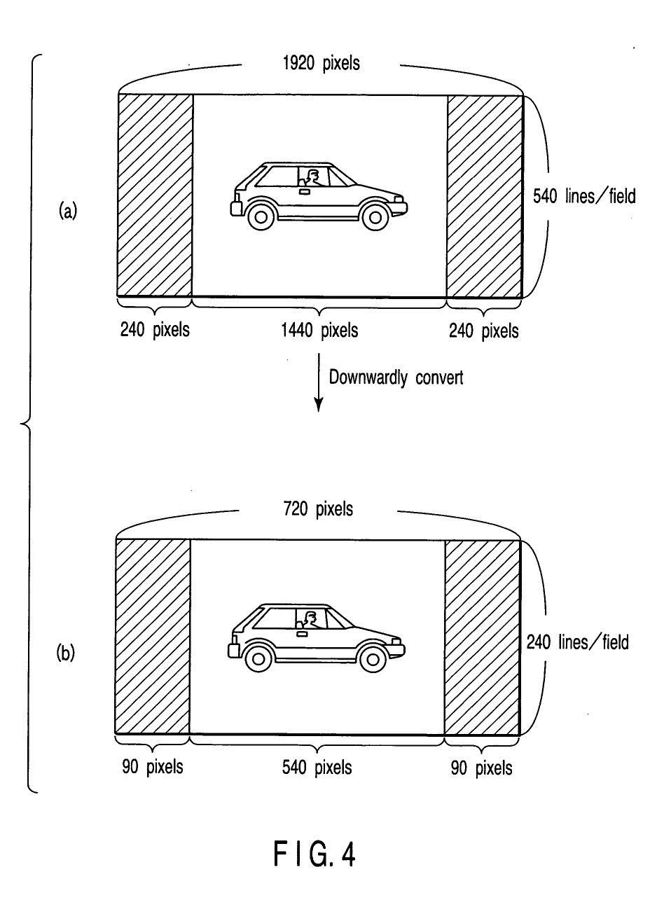

In this case, the HDTV picture signal with side panel images outputted from the MPEG decoder 15 is supplied to the down converter 18. Here, with respect to the HDTV picture signal with side panel images, as shown in reference numeral (a) of FIG. 4, it is assumed that an aspect ratio of 1920 pixels×1080i (interlace) lines/frame is 16:9, and a main screen portion has an aspect ratio of 4:3 in 1440 pixels×1080i lines/frame.

The down converter 18 converts the picture signal which conforms to the HDTV picture format shown in reference numeral (a) of FIG. 4 into the SDTV picture signal having an aspect ratio of 16:9 in 720 pixels×480i lines/frame, as shown in reference numeral (b) of FIG. 4.

In the case where the information indicating a picture format indicates the HDTV video format, and the information indicating the presence or absence of side panel images indicates the presence of the side panel image, the control section 19 controls the selector 17 so as to select an output of the down converter 18. Thus, the SDTV picture signal outputted from the down converter 18 is supplied to the picture processing section 24.

The picture processing section 24, as described previously, applies picture processing between frames or between fields to the picture signal which conforms to the SDTV picture format. This makes it possible to reduce a cross color interference or a dot interference included in the SDTV picture.

Then, the SDTV picture signal is supplied to an up converter 25 while the cross color interference or dot interference is reduced by the picture processing section 24. The up converter 25 converts the SDTV picture signal with the side panel shown in reference numeral (b) of FIG. 4 into the size of the HDTV picture format, and outputs the converted signal.

In addition, in the case where the information indicating a picture format indicates the HDTV picture format, and the information indicating the presence or absence of side panel images indicates the presence of the side panel, the control section 19 controls the selector 16 so as to select an output of the up converter 25. Thus, the picture signal which conforms to the HDTV picture format, outputted from the up converter 25, is supplied to the display device 23 via the output terminal 22, and the picture which conforms to the HDTV picture format is displayed.

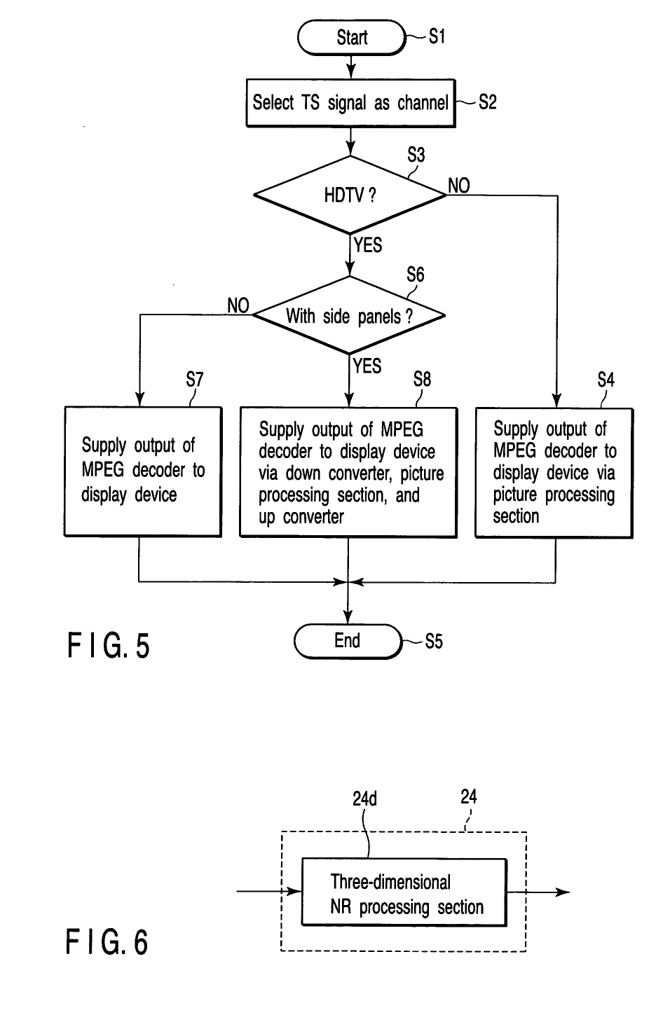

FIG. 5 is a flow chart illustrating an operation in accordance with the above-described first embodiment. That is, after processing has been started (step S1), when the tuner section 14 selects a TS signal of a predetermined channel as a channel in step S2, the control section 19 determines whether or not the received picture signal conforms to the HDTV picture format in step S3.

Then, when the determination result is negative (NO), the control section 19 determines that the received picture signal conforms to the SDTV picture signal format. In step S4, the control section controls an output of the MPEG decoder 15 so as to be supplied to the display device 24 via the selector 17, the picture processing section 24 and the selector 16, and terminates processing (step S5).

In addition, when the determination result is affirmative (YES) in step S3, the control section 19 determines whether or not the received signal is provided with side panel images in step S6. When the determination result is negative (NO), the control section 19 determines that the received picture signal conforms to the HDTV picture format. In step S7, the control section controls an output of the MPEG decoder 15 so as to be supplied to the display device 24 via the selector 16, and terminates processing (step S5).

Further, when the determination result is affirmative (YES) in step S6, the control section 19 determines the received picture signal is a pseudo HDTV picture signal. In step S8, the control section controls an output of the MPEG decoder 15 so as to be supplied to the display device 24 via the down converter 18, the picture processing section 24 and the up converter 25, and terminates processing (step S5).

According to the above-described first embodiment, having thus received a pseudo HDTV picture signal obtained by upwardly converting a composite format picture signal which conforms to the SDTV picture format to add side panel images, the received picture signal is converted into the SDTV picture format by the down converter 18, and three-dimensional YC separation processing is applied to the converted signal by the picture processing section 24. Next, a cross color interference or a dot interference is reduced with high performance, and an image quality is improved. Then, the processed image is converted into the HDTV picture format so as to be displayed as a picture. This makes it possible to display a high quality picture having a cross color interference or a dot interference with respect to the pseudo HDTV picture signal.

In the above-described first embodiment, the picture transmitted in HDTV size is displayed as a picture in HDTV size by the display device 23, and the picture transmitted in SDTV size is displayed as a picture in SDTV size by the display device 23. Thus, when a pseudo HDTV picture signal is transmitted, the transmitted signal is converted from SDTV size to HDTV size by using the up converter 25 in order to display a picture in HDTV size. However, when a picture in SDTV size is displayed, the processing by the up converter 25 is not necessary.

When the display device 23 always displays a picture in HDTV size, an output of the picture processing section 24 is always converted into HDTV size by the up converter 25. In the case of the SDTV picture signal and the HDTV picture signal with the side panel image, the selector 16 may be controlled so as to select the output of the up converter 25.

The picture processing section 24, as shown in FIG. 6, can reduce a cross color interference or a dot interference by using a three-dimensional noise reduction (NR) processing 24d.

### Second Embodiment

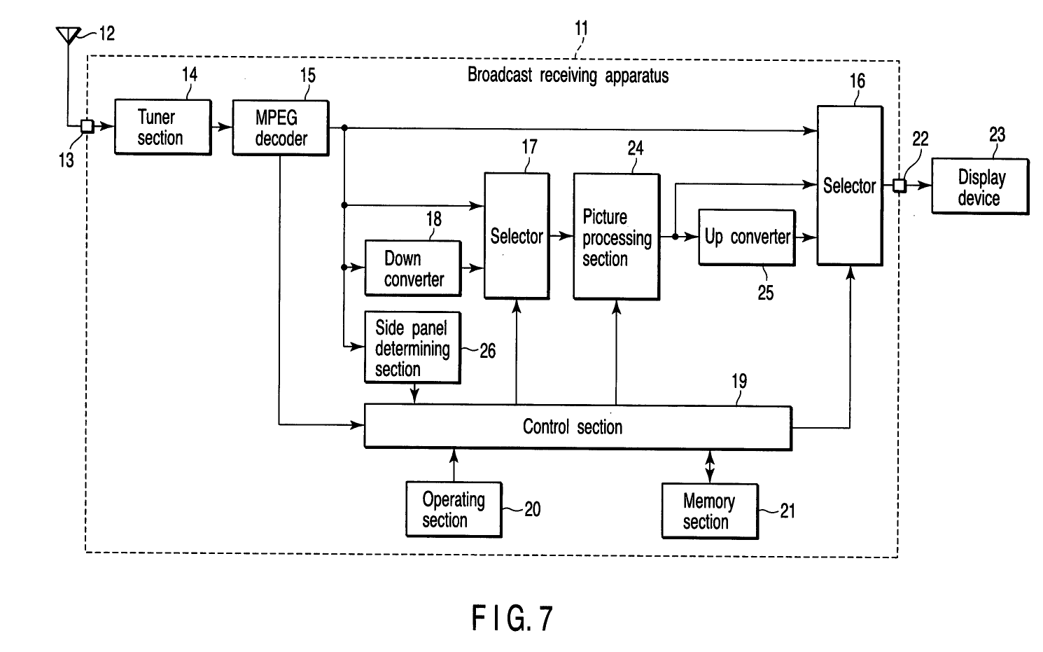

FIG. 7 shows a second embodiment of the present invention. That is, in the first embodiment shown in FIG. 1, information indicating a picture format and information indicating the presence or absence of side panel images are transmitted from a broadcast station. By combining these two items of information, it is determined whether or not an HDTV picture signal with side panel images is generated.

The second embodiment shown in FIG. 7 shows a case in which the information indicating the presence or absence of side panel images is not transmitted from the broadcast station, and only the information indicating a picture format is transmitted. In FIG. 7, like constituent elements in FIG. 1 are designated by like reference numerals. A picture signal outputted from the above MPEG decoder 15 is supplied to a side panel determining section 26.

The side panel determining section 26 makes determination of whether or not side panel images are added to the picture signal outputted from the MPEG decoder 15, and outputs the determination result to the control section 19. The determination of whether or not the side panel images are added to the picture signal is achieved by determining the presence or absence of the side panel images from icons on a field by field base, and further, making determination in a time direction of whether or not a state in which the side panel images are present continues for a predetermined period of time.

The above control section 19 controls the selector 16 or 17 by combining the determination result of the side panel determining section 26 with the information indicating a picture format, instead of the information indicating the presence or absence of the side panel images transmitted from the broadcast station in the first embodiment. Namely, in the case where the information indicating a picture format indicates the HDTV picture format, and the determination result of the side panel determining section 26 indicates the presence of the side panel images, the control section 19 determines that a pseudo HDTV picture signal is generated. Then, the control section controls an output of the MPEG decoder 15 so as to be supplied to the display device 24 via, the down converter 18, the picture processing section 24 and the up converter 25.

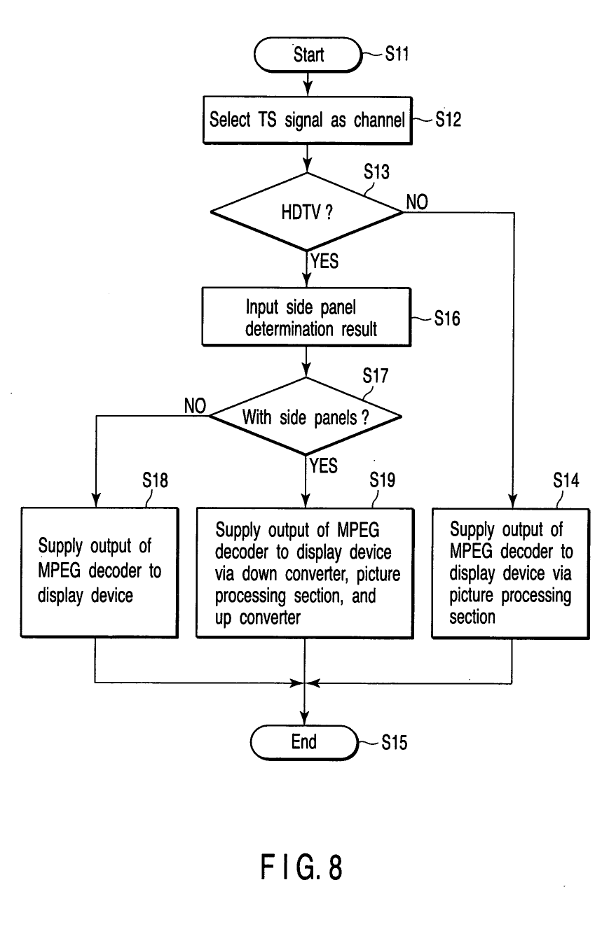

FIG. 8 is a flow chart illustrating an operation of the above-described second embodiment. That is, after processing has been started (step S11), when the tuner section 14 selects a TS signal of a predetermined channel as a channel in step S12, the control section 19 determines whether or not the received picture signal conforms to an HDTV picture format in step S13.

When the determination result is negative (NO), the control section 19 determines that the received picture signal conforms to an SDTV picture format. In step S14, the control section controls an output of the MPEG decoder 15 so as to be supplied to the display device 24 via the selector 17, the picture processing section 24, and the selector 16, and terminates processing (step S15).

In addition, when the determination result is affirmative in step S13 (YES), the control section 19 inputs the determination result of the side panel determining section 26 in step S16, and determines whether or not the received signal is provided with the side panel images in step S17.

When the determination result is negative (NO), the control section 19 determines that the received picture signal conforms the HDTV picture format. In step S18, this control section controls an output of the MPEG decoder 15 so as to be supplied to the display device 24 via the selector 16, and terminates processing (step S15).

Further, when the determination result is affirmative in step S17 (YES), the control section 19 determines that the received picture signal is a pseudo HDTV picture signal. In step S19, the control section controls an output of the MPEG decoder 15 so as to be supplied to the display device 24 via the down converter 18, the picture processing section 24 and the up converter 25, and terminates processing (step S15).

According to the above-described second embodiment, even if information indicating the presence or absence of side panel images is not transmitted from the broadcast station side, an operation similar to that in the first embodiment described previously is achieved, and a similar advantageous effect can be attained.

### Third Embodiment

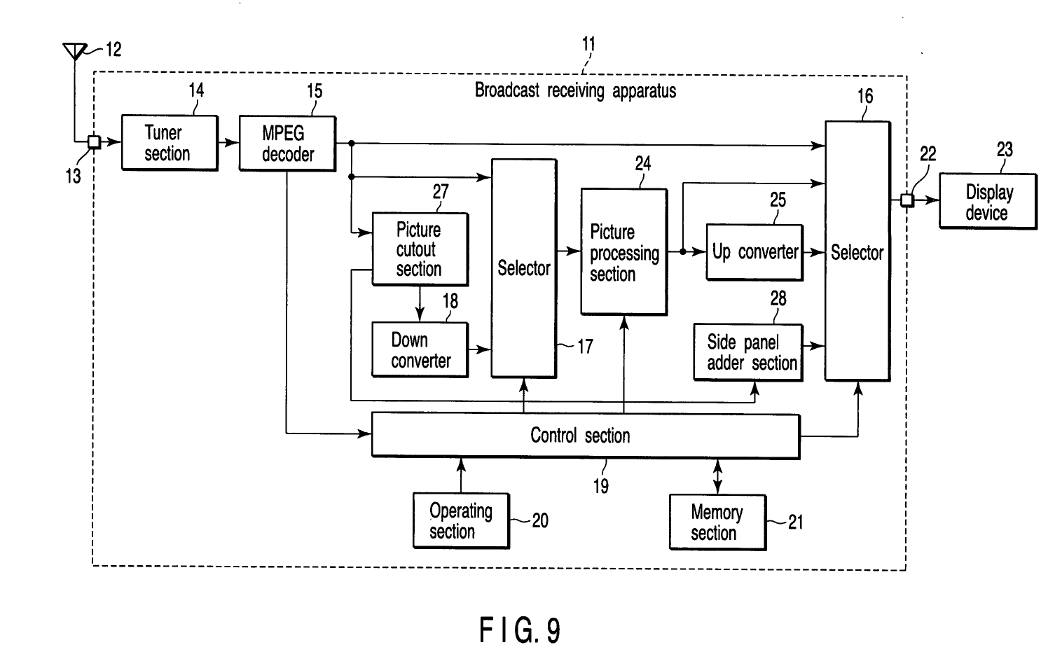

FIG. 9 shows a third embodiment of the present invention. That is, in the first embodiment shown in FIG. 1, a picture signal with side panels outputted from the MPEG decoder 15 is converted into an SDTV picture format having an aspect ratio of 16:9, as shown in reference numeral (b) of FIG. 4, by the down converter 18.

In this case, assuming that a picture portion of a composite format picture signal which conforms to the SDTV picture format at the broadcast station side shown in FIG. 2 has a 720 pixels×480i lines/frame and an aspect ratio of 4:3, the picture portion of the picture signal outputted from the down converter 18 is of size of 540 pixels×480i lines/frame. Thus, the pixel information is reduced, and the resolution is degraded.

In addition, a squeeze signal which conforms to an SDTV picture format having an aspect ratio of 16:9 is generated in response to a composite format picture signal having an aspect ratio of 4:3 shown in FIG. 2. Thus, a frequency of a cross color interference or a dot interference included in a picture signal outputted from the down converter 18 is shifted.

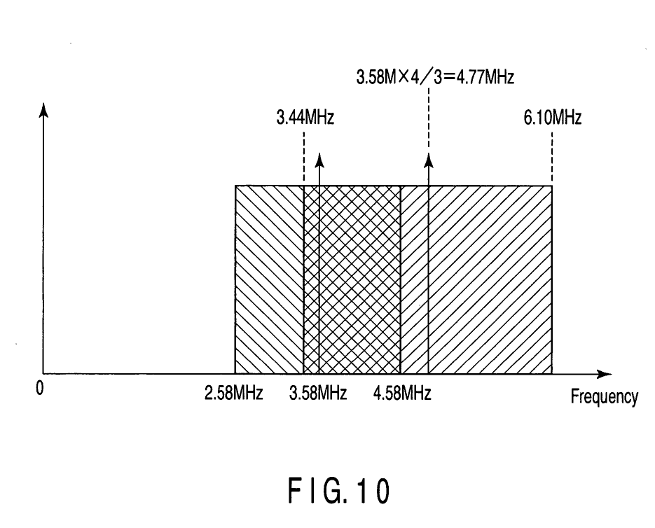

FIG. 10 shows a frequency spectrum of a luminescence signal. In the NTSC system, assuming that a color sub-carrier frequency is about 3.5 MHz, and a color signal frequency bandwidth ranges from 0 to 1 MHz, the modulated color signal frequency ranges from 2.58 MHz to 4.58 MHz. If YC separation is incomplete at the broadcast station side, the color signal component is obtained as the remaining dot interference with the luminescence signal.

The dot interference having thus remained in the picture signal outputted from the down converter 18 is obtained as a picture portion similar to that obtained by horizontally compressing a composite format picture signal by 4/3 times. Thus, the color sub-carrier frequency is obtained as a component of 3.58×(4/3) 4.77 MHz, and the dot interference component of the output of the down converter 18 is frequency-shifted in the range of 3.44 MHz to 6.10 MHz.

Therefore, although there is no problem in the case where the above picture processing section 24 carries out three-dimensional picture processing in a full bandwidth of a horizontal frequency, the dot interference component of the output of the down converter 18 deviates from the color sub-carrier in the case where three-dimensional picture processing is carried out while a bandwidth is restricted to the vicinity of the color sub-carrier frequency. Thus, there occurs a case that dot interference cannot be reduced. This also applies for a cross color interference.

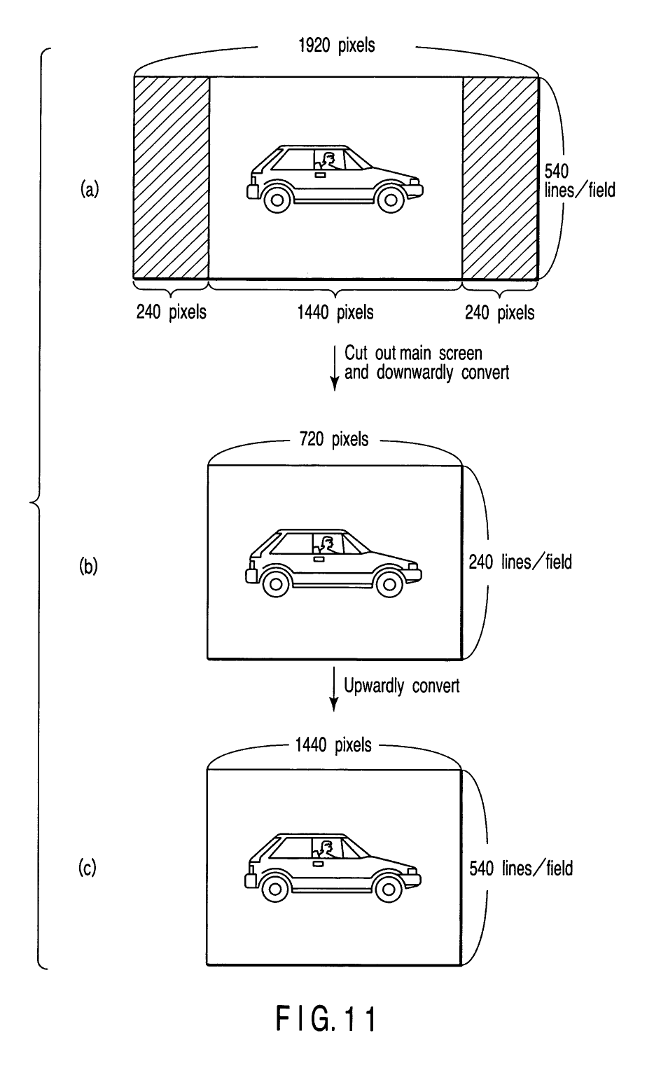

In the third embodiment shown in FIG. 9, like constituent elements in FIG. 1 are designated by like reference numbers. A picture cutout section 27 is interposed at the front stage of the down converter 18, causing the cutout section to carry out cutout of a main screen picture portion from a picture signal outputted from the MPEG decoder 15. Here, as shown in reference numeral (a) of FIG. 11, a picture for 1440 pixels is cut out after 24 pixels of a start position of a picture period of an HDTV picture signal with side panel images.

The main screen picture portion is thus cut out from the HFTV picture signal with the side panel image, and the cutout section is supplied to the down converter 18, whereby the SDTV picture signal having an aspect ratio of 4:3 can be obtained as shown in reference numeral (b) of FIG. 11.

The output of the down converter 18 shown in reference numeral (b) of FIG. 11 becomes identical to the composite format picture signal shown in FIG. 2 in picture size and in picture frequency bandwidth. Therefore, even when the picture processing section 24 carries out three-dimensional picture processing while a bandwidth is restricted to the vicinity of the color sub-carrier frequency, a cross color interference or a dot interference can be reduced.

Then, the output of the picture processing section 24 is converted into a picture signal having an aspect ratio of 4:3 in 1440 pixels×1080i lines/frame, and the converted signal is supplied to a side panel adder section 28, as shown in reference numeral (c) of FIG. 11.

The side panel adder section 28 adds side panel images each having 240 pixels×1080i lines/frame at both ends of the picture outputted from the up converter 25, respectively, thereby generating an HDTV picture signal having an aspect ratio of 16:9 in 1920 pixels×1080i lines/frame and outputting the generated signal to the selector 16.

In this case, the side panel adder section 28 causes a memory or the like to store information on separated side panel images when the picture cutout section 27 has cut out the main screen picture portion. The stored information is supplied to the side panel adder 28, thereby obtaining side panel images to be added. In this case, as long as character information or the like is superimposed on the side panel images, the stored information may be outputted from the picture cutout section 27 to the side panel adder section 28 in association with a display timing of the character information.

The side panel adder section 28 can add the side panel image each having an arbitrary fixed value or can prepare an arbitrary graphic image so as to add the graphic image as side panel images.

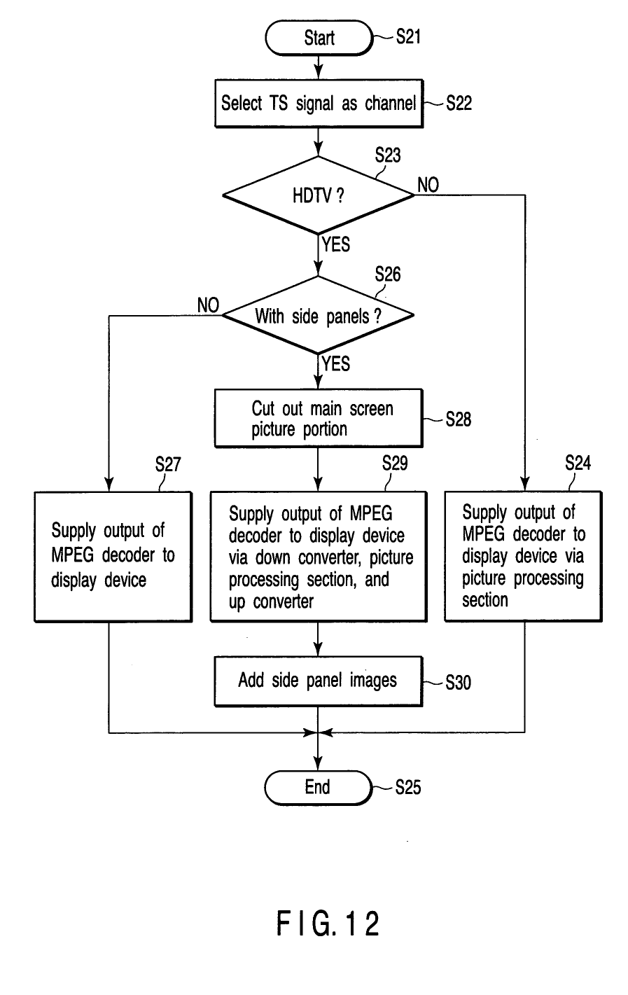

FIG. 12 is a flow chart illustrating an operation of the above-described third embodiment. That is, after processing has been started (step S21), when the tuner section 14 selects a TS signal of a predetermined channel as a channel in step S22, the control section 19 determines whether or not the received picture signal conforms to an HDTV picture format in step S23.

When the determination result is negative (NO), the control section 19 determines that the received picture signal conforms to an SDTV picture signal format. In step S24, the control section controls an output of the MPEG decoder 15 so as to be supplied to the display device 24 via the selector 17, the picture processing section 24, and the selector 16, and terminates processing (step S25).

In addition, when the determination result is affirmative in step S23 (YES), the control section 19 determines whether or not the received signal is provided with side panel images in step S26. When the determination result is negative (NO), the control section 19 determines that the received picture signal conforms to the HDTV picture format. In step S27, the control section controls an output of the MPEG decoder 15 so as to be supplied to the display device 24 via the selector 16, and terminates processing (step S25).

Further, when the determination result is affirmative in step S26 (YES), the control section 19 determines that the received picture signal is a pseudo HDTV picture signal. In step S28, this control section controls the main screen picture portion to be cut out from the output of the MPEG decoder 15. In step S29, the control section controls the cutout picture portions to be sequentially supplied to the down converter 18, the picture processing section 24, and the up converter 25.

Then, in step S30, the control section 19 controls the output of the up converter 25 to be supplied to the display device 24 by adding side panel images to the output, and terminates processing (step S25).

According to the above-described third embodiment, the main screen picture portion is cut out from the HDTV picture signal with side panel images so as to convert the cutout main screen picture portion into the SDTV picture format by the down converter 18. Thus, the converted picture portion can be returned to the same size as the composite format picture signal at the broadcast station side.

Therefore, even with a configuration in which the picture processing section 24 carries out three-dimensional picture processing while a bandwidth is restricted to the vicinity of the color signal bandwidth, it becomes possible to reduce a cross color interference or a dot interference of an HDTV picture signal with side panel images.

The present invention is not limited to the above-described embodiments. At the stage of implementation, the present invention can be carried out by variously modifying constituent elements without departing from the spirit of the invention. In addition, a variety of inventions can be formed by properly combining a plurality of constituent elements disclosed in the above-described embodiments. For example, some of all the constituent elements disclosed in the embodiments may be eliminated. Further, constituent elements according to different embodiments may be combined with each other.

1. A broadcast receiving apparatus comprising:
a receiver section configured to receive a digital broadcast in which there coexist a first picture signal which conforms to a standard picture format, a second picture signal which conforms to a high image quality picture format, and a third picture signal obtained by converting a composite format picture signal which conforms to a standard picture format into a high image quality picture format and adding side panels;
a signal processing section configured to extract a signal of a predetermined channel from a digital broadcast signal received by the receiver section and apply decoding processing;
a determining section configured to determine whether a picture signal outputted from the signal processing section is any of the first to third picture signals;
a first processing section configured to guide to a picture display device the second picture signal which is selected in the case where the determining section determines that the picture signal outputted from the signal processing section is the second picture signal, and which is outputted from the signal processing section;
a second processing section configured to convert into a composite format picture signal the first picture signal which is selected in the case where the determining section determines that the picture signal outputted from the signal processing section is the first picture signal, and which is outputted from the signal processing section, followed by applying three-dimensional picture processing to the converted signal and guiding the processed signal to the picture display device; and
a third processing section configured to convert into a composite format picture signal which conforms to a standard picture format the first picture signal which is selected in the case where the determining section determines that the picture signal outputted from the signal processing section is the third picture signal, and which is outputted from the signal processing section, followed by applying three-dimensional picture processing to the converted signal and guiding the processed signal to the picture display device.

2. A broadcast receiving apparatus according to claim 1, wherein the determining section is configured to determine whether the picture signal outputted from the signal processing section is any of the first to third picture signals based on first information indicating a picture format and second information indicating the presence or absence of side panels, the information being transmitted to be included in the digital broadcast signal.

3. A broadcast receiving apparatus according to claim 1, wherein the determining section comprises a side panel determining section configured to determine the presence or absence of side panels from the picture signal outputted from the signal processing section, and is configured to determine whether the picture signal outputted from the signal processing section is any of the first to third picture signals based on a determination result of the side panel determining section and information indicating a picture format transmitted to be included in the digital broadcast signal.

4. A broadcast receiving apparatus according to claim 1, wherein the third processing section comprises:
a down converter configured to convert the third picture signal outputted from the signal processing section into a standard picture format; and
a picture processing section configured to convert an output of the down converter into a composite format picture signal and apply three-dimensional YC separation processing to the converted signal.

5. A broadcast receiving apparatus according to claim 1, wherein the third processing section comprises:
a down converter configured to convert the third picture signal outputted from the signal processing section into a standard picture format;
a picture processing section configured to convert an output of the down converter into a composite format picture signal and apply three-dimensional YC separation processing to the converted signal; and
an up converter configured to convert an output of the picture processing section into a high image quality picture format.

6. A broadcast receiving apparatus according to claim 1, wherein the third processing section comprises:
a picture cutout section configured to cut out a main screen picture portion from the third picture signal outputted from the signal processing section;
a down converter configured to convert the main screen picture portion cut out by the picture cutout section into a standard picture format;
a picture processing section configured to convert an output of the down converter into a composite format picture signal and apply three-dimensional YC separation processing to the converted signal;
an up converter configured to convert an output of the picture processing section into a high image quality picture format; and
a side panel adder section configured to add side panels to an output of the up converter.

7. A broadcast receiving apparatus according to claim 6, wherein the picture cutout section is configured to store information on side panels separated when cutout of the main screen picture portion has been carried out, and
the side panel adder section is configured to add side panels based on the information stored in the picture cutout section.

8. A broadcast receiving method comprising:
a first step of receiving a digital broadcast in which there coexist a first picture signal which conforms to a standard picture format, a second picture signal which conforms to a high image quality picture format, and a third picture signal obtained by converting a composite format picture signal which conforms to a standard picture format into a high image quality picture format and adding side panels;
a second step of extracting a signal of a predetermined channel from a received digital broadcast signal and applying decoding processing;
a third step of determining whether the decided picture signal is any of the first to third picture signals;
a fourth step of, when it is determined that the decoded picture signal is the second picture signal, guiding the second picture signal to a picture display device;
a fifth step of, when it is determined that the decoded picture signal is the first picture signal, converting the first picture signal into a composite format picture signal, followed by applying three-dimensional picture processing to the converted signal and guiding the processed signal to the picture display device; and
a sixth step of, when it is determined that the decoded picture signal is the third picture signal, converting the third picture signal into a composite format picture signal which conforms to a standard picture format, followed by applying three-dimensional picture processing to the converted signal and guiding the processed signal to the picture display device.

9. A broadcast receiving method according to claim 8, wherein the third step makes determination based on first information indicating a picture format and second information indicating the presence or absence of side panels, the information being transmitted to be included in the digital broadcast signal.

10. A broadcast receiving method according to claim 8, wherein the third step comprises a step of determining the presence or absence of side panels from the decoded picture signal, the determination step making determination based on a determination result of the presence or absence of the side panels and the information indicating a picture format transmitted to be included in the digital broadcast signal.

11. A broadcast receiving method according to claim 8, wherein the sixth step comprises:
a step of converting the decoded third picture signal into a standard picture format;
a step of converting into a composite format picture signal the picture signal converted into the standard picture format to apply three-dimensional YC separation processing to the converted signal; and
a step of converting an output obtained after the three-dimensional YC separation processing into a high image quality picture format.

12. A broadcast receiving method according to claim 8, wherein the sixth step comprises:
a step of cutting out a main screen picture portion from the decoded third picture signal;
a step of converting the cutout main screen picture portion into a standard picture format;
a step of converting into a composite format picture signal the picture signal converted into the standard picture format to apply three-dimensional YC separation processing to the converted signal;
a step of converting an output obtained after the three-dimensional YC separation processing into a high image quality picture format; and
a step of adding side panels to the picture signal converted into the high image quality picture format.
